(19) United States
(12) Patent Application Publication
(10) Pub. No.: US 2015/0193010 A1
(43) Pub. Date: Jul. 9, 2015

(54) HARDWARE KEYBOARD FOR DISPLAY KEYBOARD

(71) Applicant: Lenovo (Singapore) Pte. Ltd., New Tech Park (SG)

(72) Inventors: Yasumichi Tsukamoto, Kanagawa-ken (JP); Osamu Yamamoto, Kanagawa-ken (JP); Yoshio Nakamura, Kanagawa-ken (JP); Masayuki Amano, Kanagawa-ken (JP); Seiji Yamasaki, Kanagawa-ken (JP)

(73) Assignee: Lenovo (Singapore) Pte. Ltd., New Tech Park (SG)

(21) Appl. No.: 14/147,336

(22) Filed: Jan. 3, 2014

(51) Int. Cl. G06F 3/02; G06F 3/044

(52) U.S. Cl. CPC G06F 3/0221; G06F 3/044

(57) ABSTRACT

A keyboard module for use with touchscreen displays may provide more than one function associated with one or more keys. Activation of touchscreen keys may be triggered by providing detection of more than one contact type for a key. A key may include a first contact path with a first touchscreen key and a second contact path with a second touchscreen display key. Activation of the touchscreen keys may be triggered depending on the type of contact made with the key.

### BACKGROUND OF THE INVENTION

The present invention generally relates to electronic accessories and, more particularly, to hardware keyboards that may be attachable to an electronic display keyboard.

Some electronic devices include an interface that may provide a touch display keyboard. The touch display keyboard may be operated by the user making physical contact with the display activating areas of the display that represent a keyboard key. For some users, repeated tapping of a glass display may be undesirable. Some touch display keyboards may be inaccurate at discerning which keyboard key may have been touched on the display. Thus, it may be desirable to provide a mechanical input device with which users may be more comfortable.

For example, it is known to provide peripheral detachable keyboards which may click into a port of the electronic device. The keyboard may be a typical keyboard layout (for example, a QWERTY layout) which may be larger than the electronic device. For some, the size of the keyboard may negate any portable convenience provided by the size of the electronic device. The keyboard may override the touch display and be used in a conventional two-handed typing manner so that the keys on the touch display may not be operated.

Another type of input device may slide over the device display and provide depressible buttons which may activate areas of the display. However, the key size of a typical keyboard may be far larger than the keys shown on the display. Thus, the screen space available on the device may not accommodate conventional mechanical keys.

As can be seen, there is a need for a detachable keyboard that may fit over a touch display and provide operation of a keyboard.

### SUMMARY OF THE INVENTION

In one aspect of the present invention, a keyboard module for positioning atop a touchscreen of an electronic device comprises a physical key; a first conductive path leading from the physical key to a first touchscreen key on the touchscreen; and a second conductive path leading from the physical key to a second touchscreen key on the touchscreen.

In another aspect of the present invention, a keyboard module for positioning atop a touchscreen of an electronic device comprises a conductive key; a conductive contact coupled to the conductive key, the conductive contact disposed to activate a first touchscreen key in response to depression of the conductive key; and a conductive layer coupled to the conductive key and to a second touchscreen key when the module is atop the touchscreen, the conductive layer configured to activate the second touchscreen key in response to the conductive key being touched without being depressed.

In another aspect of the present invention, a keyboard module comprises a frame configured for positioning atop a touchscreen of an electronic device; and a physical key held by the frame, the physical key coupled to both a first touchscreen key and a second touchscreen key on the touchscreen, the physical key configured to provide to the touchscreen: a first signal indicating a first type of user contact, and a second signal indicating a second type of user contact, wherein the first signal is configured to activate the first touchscreen key and the second signal is configured to activate the second touchscreen key.

These and other features, aspects and advantages of the present invention will become better understood with reference to the following drawings, description and claims.

### BRIEF DESCRIPTION OF THE DRAWINGS

FIG. 1 is an exploded perspective side view of an exemplary embodiment of the present invention;

FIG. 2 is an exploded perspective side view of the detachable keyboard of FIG. 1;

FIG. 3 is a partial cross-sectional side view of keys from the keyboard of FIG. 2 showing operation of a key function without depressing the key; and

FIG. 4 is a partial cross-sectional side view of keys from the keyboard of FIG. 2 showing operation of a key function by depressing the key.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The present invention generally provides an input device that may fit over the touch display of an electronic device. The input device may provide multiple key functions by the operation of a single key. Access to multiple key functions by a single key may allow the use of mechanical keys to accurately depress touch display keys without exceeding the width of the electronic device.

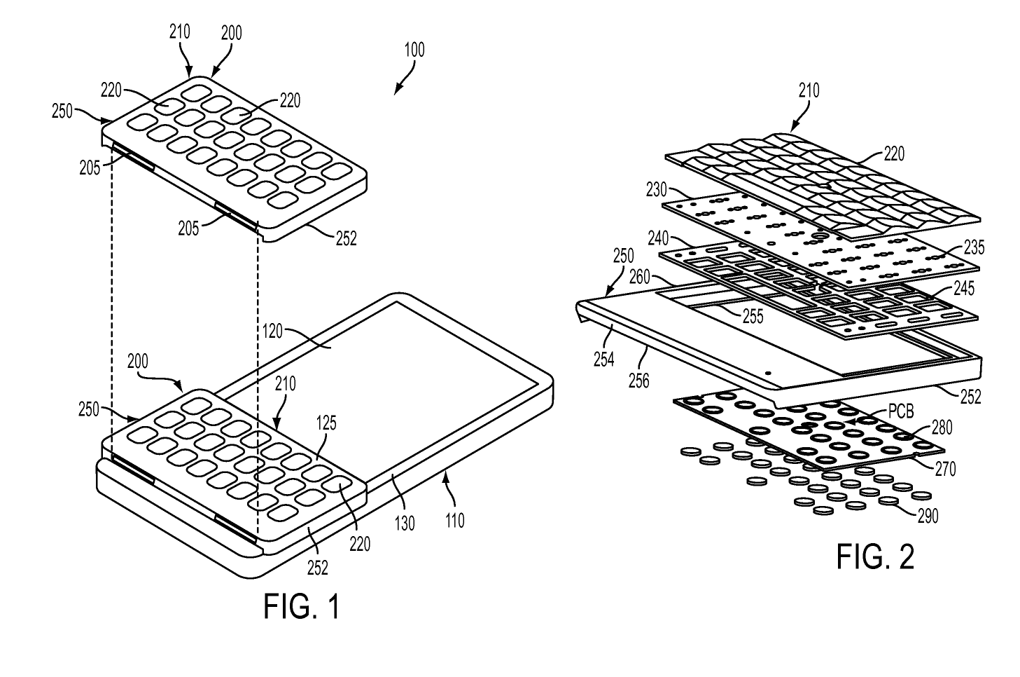

Referring to FIG. 1, a system 100 which may include an electronic device 110 and a keyboard module 200 is shown according to an exemplary embodiment of the present invention. The electronic device may for example be a mobile phone, smartphone, or tablet type device. The electronic device 110 may include a touchscreen display 120. As used herein, the term “touchscreen” is used to describe electronic displays with tactile sensory. A touchscreen keyboard area 125 may include a software based keyboard display which may be activated by, for example, capacitance detection. The keyboard module 200 may be positioned over the keyboard area 125. It will be understood that the keyboard area 125 is obstructed from view by the keyboard module 200 in FIG. 1. In some embodiments, side walls 252 of frame 250, of the keyboard module 200, may slide over side walls 130 of the electronic device 110. In some embodiments, a fastener 205 may secure the frame 250 to the electronic device 110. For example, the fastener 205 may be a magnet that may be attracted to metal in the electronic device 110. The keyboard module 200 may include a plurality of physical keys 220 which, when contacted, may trigger functions in the keyboard area 125.

Referring now to FIG. 2, the keyboard module 200 is shown exploded in accordance with an exemplary embodiment of the present invention. The plurality of keys 220 may be arranged in a keyboard 210. In some embodiments, the keys 220 may individually include more than one indicia. For example, a primary indicia may indicate a first function associated with use of the key 220 and a secondary indicia may indicate a second function associated with the key 220. A flexible layer 230, for example, a rubber sheet, may be under the keys 220. The flexible layer 230 may include vias 235 positioned to permit contact of the keys 220 to underlying elements. In some embodiments, the flexible layer 230 may be supported by a rigid frame 240, for example, a plastic frame. The rigid frame 240 may include openings 245. The openings 245 may be configured to approximate the shape of overlying keys 220.

The frame 250 may include a body 254 that may include side walls 252. A slot 256 may extend between the side walls 252. The slot 256 may be configured to receive the electronic device 110 (FIG. 1) between the side walls 252. The frame 250 may include a window 255. The window 255 may include a ledge 260 disposed to support the receipt of the keyboard 210, the flexible layer 230, and the rigid frame 240.

A plurality of conductive contacts 280 may be positioned under the frame 250. The conductive contacts 280 may be, for example, flexible metal domes that may flex when contacted by the keys 220. The conductive contacts 280 may be positioned under the keys 220. A printed circuit board (PCB) layer 270 may support the conductive contacts 280. A plurality of conductive pads 290 may be positioned under the PCB layer 270. The conductive pads 290 may be positioned in predetermined locations which may correspond with locations of keys (not shown) in the keyboard area 125 (FIG. 1). In an embodiment, the number of conductive pads 290 may be more than the number of keys 220.

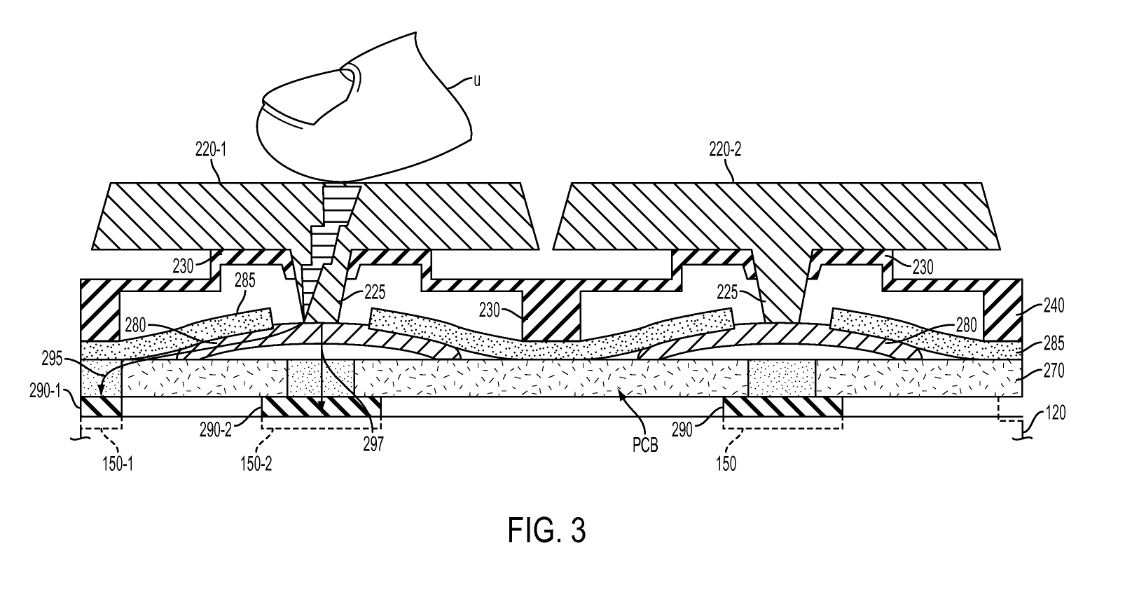

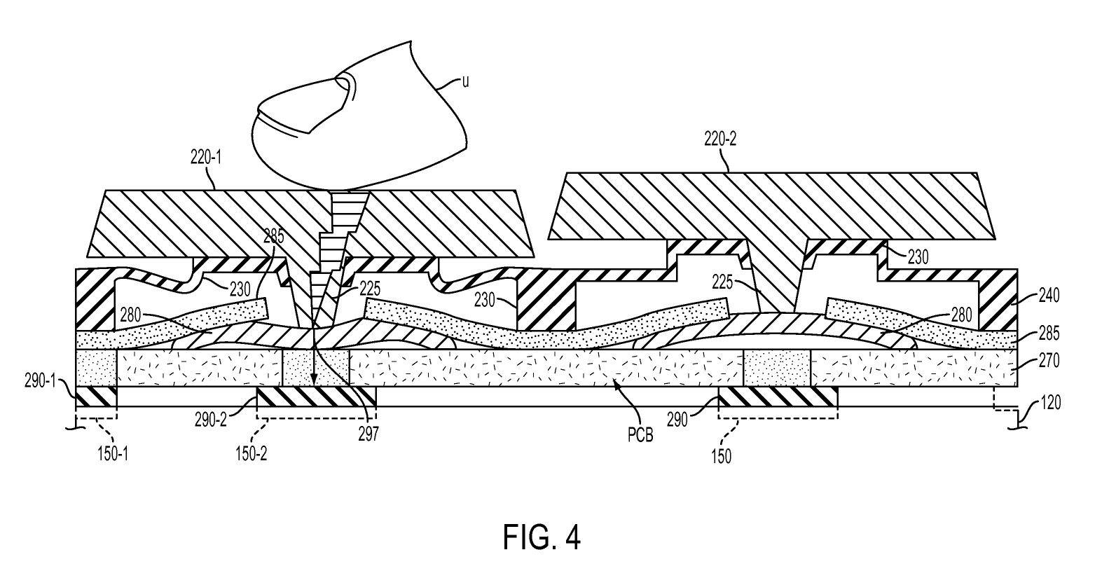

Referring now to FIGS. 3 and 4, an end view of juxtaposed keys 220-1 and 220-2 over the display 120 are shown according to an exemplary embodiment of the present invention. In general, each key 220-1 and 220-2 may be activated by two different manners of user contact. The keys 220-1 and 220-2 may be conductive (for example, metal keys). Depending on the type of user contact detected, a different keyboard function corresponding to a touchscreen key 150 (for example, a digital key shown on the display 120) may be activated. A first conductive path 295 (represented by arrow 295) may be connected between the physical key 220 and a first touchscreen key 150-1 on the touchscreen display 120. A second conductive path 297 (represented by arrow 297) may be connected between the key 220 to a second touchscreen key 150-2.

The keys 220 may include a stem 225 (which may be conductive) projecting through the flexible layer 230. In a default state, the keys 220 may not be depressed. The keys 220 may be biased to the default state by the flexible layer 230 supported on the rigid frame 240. Depression of keys 220 may be resisted by the flexible layer 230 providing a spring return of the keys 220. The conductive contact 280 may be unflexed and in contact with the stem 225 in the default state. The conductive contact 280 may rest atop the PCB layer 270. A conductive pad 290-2 may be disposed centrally under the conductive contact 280 and over the touchscreen key 150-2. In an exemplary embodiment, a conductive layer 285, for example, a conductive polyethylene terephthalate (PET) sheet may be in contact with the conductive contact 280.

The conductive layer 285 may extend from the conductive contact 280 into contact with another conductive pad 290-1 disposed peripherally from the stem 225, which may be over the touchscreen key 150-1 also positioned peripherally from the stem 225.

In an exemplary embodiment shown in FIG. 3, the touchscreen key 150-1 may be activated by detecting a user (U) contacting the key 220-1. Contact by the user (U) may provide an electrical impulse through the key 220 which may be sensed by the touchscreen display 120. The key 220-1 does not necessarily need to be depressed for the touchscreen display 120 to detect contact. Preferably, a light touch or slide of the user's finger across the key 220-1 may trigger detection of a first keyboard function. The naturally occurring charge of the user (U) may be conducted through the key 220-1 to the conductive contact 280 through the conductive layer 285 and to the peripherally positioned conductive pad 290-1 activating the peripherally positioned touchscreen key 150-1, the path of which may define the conductive path 295.

In an exemplary embodiment shown in FIG. 4, the touchscreen key 150-2 may be activated by detecting the user (U) depressing the samekey 220-1. FIG. 4 is similar to FIG. 3 except that the key 220-1 is shown in a depressed state. The depression of the key 220-1 may flex the conductive contact 280 through the PCB layer 270 into contact with the centrally positioned conductive pad 290-2, the path of which may define the conductive path 297. The contact of the centrally positioned conductive pad 290-2 may trigger detection of the centrally positioned touchscreen key 150-2, thus providing a second keyboard function corresponding to the key 220-1. In some embodiments, the conductive pad 290 may be rubber which may protect the touch display 120 from damage by metal parts such as the stem 225.

It should be understood, of course, that the foregoing relates to exemplary embodiments of the invention and that modifications may be made without departing from the spirit and scope of the invention as set forth in the following claims.

What is claimed is:

1. A keyboard module for positioning atop a touchscreen of an electronic device, comprising:
a physical key;
a first conductive path leading from the physical key to a first touchscreen key on the touchscreen; and
a second conductive path leading from the physical key to a second touchscreen key on the touchscreen.

2. The keyboard module of claim 1, wherein the physical key is conductive.

3. The keyboard module of claim 1, wherein the physical key is metallic.

4. The keyboard module of claim 1, further comprising a first indicia on the physical key corresponding to a keyboard function associated with the first touchscreen key and a second indicia on the physical key corresponding to a keyboard function associated with the second touchscreen key.

5. The keyboard module of claim 1, wherein the first conductive path is configured to be activated by a first type of user contact and the second conductive path is configured to be activated by a second type of user contact.

6. The keyboard module of claim 5, wherein the first type of user contact is based on detecting a touch of the physical key without depressing the physical key.

7. The keyboard module of claim 6, wherein the second type of user contact is based on detecting depression of the physical key.

8. A keyboard module for positioning atop a touchscreen of an electronic device, comprising:
a conductive key;
a conductive contact coupled to the conductive key, the conductive contact disposed to activate a first touchscreen key in response to depression of the conductive key; and
a conductive layer coupled to the conductive key and to a second touchscreen key when the module is atop the touchscreen, the conductive layer configured to activate the second touchscreen key in response to the conductive key being touched without being depressed.

9. The keyboard module of claim 8, further comprising a conductive stem coupled to the conductive key, the conductive stem configured to force the conductive contact into contact with the first touchscreen key.

10. The keyboard module of claim 8, further comprising a conductive pad between the conductive layer and the second touchscreen key.

11. The keyboard module of claim 10, wherein the conductive pad is a rubber pad.

12. The keyboard module of claim 8, wherein the conductive contact is a flexible metal dome.

13. The keyboard module of claim 8, wherein the touchscreen is a mobile telephone display.

14. The keyboard module of claim 8, further comprising sidewalls on the frame configured to slide over sidewalls of the electronic device.

15. A keyboard module, comprising:
a frame configured for positioning atop a touchscreen of an electronic device; and
a physical key held by the frame, the physical key coupled to both a first touchscreen key and a second touchscreen key on the touchscreen, the physical key configured to provide to the touchscreen:
a first signal indicating a first type of user contact, and
a second signal indicating a second type of user contact,
wherein the first signal is configured to activate the first touchscreen key and the second signal is configured to activate the second touchscreen key.

16. The keyboard module of claim 15, wherein the first type of user contact is a touch of the physical key without depressing the physical key.

17. The keyboard module of claim 16, wherein the second type of user contact is based on detecting depression of the physical key.

18. The keyboard module of claim 15, wherein the first signal and the second signal are electrical impulses provided by a touch of the user.

19. The keyboard module of claim 15, wherein the physical key is a metal key configured to provide electrical impulses by a touch of the user to the first touchscreen key and the second touchscreen key.

20. The keyboard module of claim 15, wherein the second type of user contact provides both the first signal and the second signal to the touchscreen.
